(19) United States
(12) Patent Application Publication
(10) Pub. No.: US 2022/0390247 A1
(43) Pub. Date: Dec. 8, 2022

(54) SERVER FOR PROVIDING PICKUP SERVICE, SYSTEM INCLUDING THE SAME, AND METHOD THEREOF

(71) Applicants: HYUNDAI MOTOR COMPANY, Seoul (KR); Kia Corporation, Seoul (KR)

(72) Inventor: Hyun Mok KIM, Seoul (KR)

(73) Assignees: HYUNDAI MOTOR COMPANY, Seoul (KR); Kia Corporation, Seoul (KR)

(21) Appl. No.: 17/545,287

(22) Filed: Dec. 8, 2021

(30) Foreign Application Priority Data
Jun. 3, 2021 (KR) 10-2021-0072379

(51) Int. Cl. G01C 21/36; G01C 21/34; G06Q 10/02; G06Q 50/30; G06F 16/955

(52) U.S. Cl. CPC G01C 21/362; G01C 21/3461; G01C 21/3492; G06Q 10/02; G06Q 50/30; G06F 16/955

(57) ABSTRACT

A server for providing a pickup service, a system including the same, and a method thereof are provided. The server includes a communication device that performs communication between a vehicle terminal of a vehicle which is traveling according to a route from a starting point to a destination and a user terminal of a user scheduled to ride in the vehicle, a processor that shares a list of pickup positions which are places where the user rides in the vehicle with the vehicle terminal or the user terminal based on a route of the vehicle and a position of the user, and a storage storing data and an algorithm run by the processor.

### CROSS-REFERENCE TO RELATED APPLICATION

The present application claims priority to Korean Patent Application No. 10-2021-0072379, filed on Jun. 3, 2021, the entire contents of which is incorporated herein for all purposes by this reference.

### BACKGROUND OF THE INVENTION

### Field of the Invention

The present invention relates to a server for providing a pickup service, a system including the same, and a method thereof, and more particularly, relates to technologies of selecting an optimal pickup position using position information shared with each other and picking up a person (a user) scheduled to ride in the vehicle.

### Description of Related art

With the development of the automotive industry, a system using wireless communication for providing various services using a wireless communication technology has been developed to provide a driver with convenience.

For driving safety, a relative position between a host vehicle and a neighboring vehicle is tracked and shared based on a global positioning system (GPS) to provide several services.

Such position sharing services are used to help communication by easily sharing a position of a user with a counterpart. However, this is limited to simply sharing a position therebetween. There is a need to provide more various services using a corresponding position sharing technology to increase convenience of users.

The information disclosed in this Background of the present invention section is only for enhancement of understanding of the general background of the present and may not be taken as an acknowledgement or any form of suggestion that this information forms the prior art already known to a person skilled in the art.

### BRIEF SUMMARY

Various aspects of the present invention are directed to providing a server for providing a pickup service to share positions between a driver and a user who is a person scheduled to ride in the vehicle when the driver picks up the person scheduled to ride in the vehicle and provide the driver of the vehicle and the user with an optimal pickup position based on a current position of the user and a route of the vehicle, a system including the same, and a method thereof.

The technical problems to be solved by the present invention are not limited to the aforementioned problems, and any other technical problems not mentioned herein will be clearly understood from the following description by those skilled in the art to which various exemplary embodiments of the present invention pertains.

According to various aspects of the present invention, a server for providing a pickup service may include a communication device that communicates with a vehicle terminal of a vehicle which is traveling according to a route from a starting point to a destination and a user terminal of a user scheduled to ride in the vehicle, a processor that shares a list of pickup positions which are places where the user rides in the vehicle with the vehicle terminal or the user terminal based on the route of the vehicle and a position of the user, and a storage storing data and an algorithm run by the processor.

In various exemplary embodiments of the present invention, the processor may extract at least one pickup position candidate within a predetermined radius from a current position of the user.

In various exemplary embodiments of the present invention, the processor may extract the at least one pickup position candidate based on at least one of the route of the vehicle, the position of the user, a movement route of the user, whether it is possible for the vehicle to stop, or a congestion situation.

In various exemplary embodiments of the present invention, the processor may extract a road or an intersection within the predetermined radius around the current position of the user as the at least one pickup position candidate.

In various exemplary embodiments of the present invention, the processor may extract a position for each direction on the road or the intersection within the predetermined radius around the current position of the user as the at least one pickup position candidate.

In various exemplary embodiments of the present invention, the processor may assign a weight to at least one pickup position candidate using at least one of a road type of the at least one pickup position candidate, a probability that the user will access the at least one pickup position candidate, a difference in time taken between an old route from the starting point to the destination and a new route rediscovered by setting the at least one pickup position candidate to a stop, a time taken for the user to reach the at least one pickup position candidate, or traffic congestion.

In various exemplary embodiments of the present invention, the processor may delete the at least one pickup position candidate, when the road type of the at least one pickup position candidate is at least one of a highway, an underpass, or an overpass.

In various exemplary embodiments of the present invention, the processor may list up a highest pickup position candidate among the at least one pickup position candidate based on the weight and may share the list of the pickup positions with the vehicle terminal and the user terminal.

In various exemplary embodiments of the present invention, the processor may determine a road type of a selected pickup position and a probability that the user will access the selected pickup position, when directly receiving selection of the pickup position from the user terminal or the vehicle terminal.

In various exemplary embodiments of the present invention, the processor may provide the user terminal or the vehicle terminal with a notification that it is impossible to pick up the user, when it is impossible for the user to access the selected pickup position on foot or when the vehicle is unable to stop on the selected pickup position.

In various exemplary embodiments of the present invention, the processor may request the user terminal or the vehicle terminal to finalize the selected pickup position, when it is possible for the user to access the selected pickup position on foot and when the vehicle is able to stop on the selected pickup position.

In various exemplary embodiments of the present invention, the processor may provide the user terminal or the vehicle terminal with a route where the selected pickup position is set to a stop, when the finalization of the selected pickup position is received from the user terminal or the vehicle terminal.

In various exemplary embodiments of the present invention, the processor may provide the user terminal or the vehicle terminal with a uniform resource locator (URL) for selecting the pickup position or guiding the user or the vehicle along a route to the finalized pickup position.

According to various aspects of the present invention, a system for providing a pickup service may include a vehicle terminal of a vehicle traveling based on a route from a starting point to a destination, a user terminal of a user scheduled to ride in the vehicle, and a server that shares a list of pickup positions which are places where the user rides in the vehicle with the vehicle terminal or the user terminal based on the route of the vehicle and a position of the user, through communication with the vehicle terminal or the user terminal.

In various exemplary embodiments of the present invention, the vehicle terminal, the user terminal, and the server may share current positions of the vehicle terminal and the user terminal with one another.

In various exemplary embodiments of the present invention, the user terminal may select one of pickup positions included in the list of the pickup positions, when receiving the list of the pickup positions from the server.

In various exemplary embodiments of the present invention, the vehicle terminal may finalize the selected pickup position, when the pickup position selected by the user terminal is shared.

In various exemplary embodiments of the present invention, the server may provide the vehicle terminal and the user terminal with a route to the selected pickup position, when the selected pickup position is finalized by the vehicle terminal.

According to various aspects of the present invention, a method for providing a pickup service may include receiving a position of a vehicle and a position of a user and a route of the vehicle from a vehicle terminal of the vehicle traveling according to the route from a starting point to a destination and a user terminal of the user scheduled to ride in the vehicle and sharing a list of pickup positions which are places where the user rides in the vehicle with the vehicle terminal or the user terminal based on the route of the vehicle and the position of the user.

In various exemplary embodiments of the present invention, the sharing of the list of the pickup positions with the vehicle terminal or the user terminal may include extracting at least one pickup position candidate within a predetermined radius from a current position of the user. The at least one pickup position candidate may be extracted based on the route of the vehicle, the position of the user, a movement route of the user, whether it is possible for the vehicle to stop, or a congestion situation.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a drawing illustrating a configuration of a system for providing a pickup service according to various exemplary embodiments of the present invention;

FIG. 2 is a block diagram illustrating a detailed configuration of a server for providing a pickup server according to various exemplary embodiments of the present invention;

FIG. 3 is a flowchart illustrating a method for providing a pickup service in a server according to various exemplary embodiments of the present invention;

FIG. 4 is a flowchart illustrating a method for selecting a pickup position according to various exemplary embodiments of the present invention;

FIG. 5A, FIG. 5B, and FIG. 5C are exemplary drawings illustrating a process of selecting a pickup position according to various exemplary embodiments of the present invention; and

FIG. 6A, FIG. 6B, FIG. 6C, and FIG. 6D are exemplary drawings illustrating a process of selecting a pickup position according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of well-known features or functions will be ruled out in order not to unnecessarily obscure the gist of the present invention.

In describing the components of the exemplary embodiment according to various exemplary embodiments of the present invention, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which various exemplary embodiments of the present invention pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

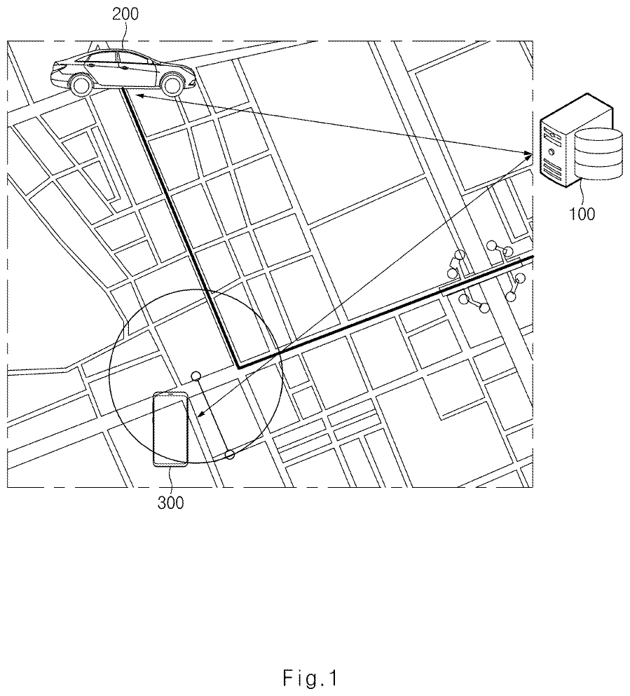

Hereinafter, embodiments of the present invention will be described in detail with reference to FIGS. 1 to 6D.

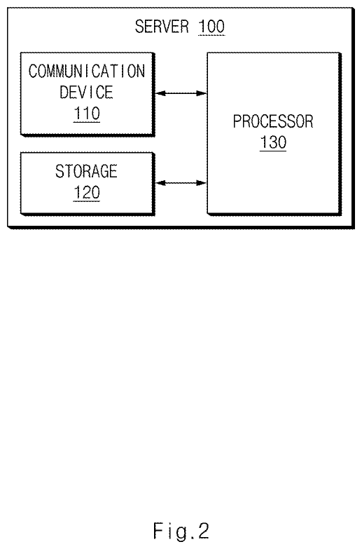

FIG. 1 is a drawing illustrating a configuration of a system for providing a pickup service according to various exemplary embodiments of the present invention. FIG. 2 is a block diagram illustrating a detailed configuration of a server for providing a pickup server according to various exemplary embodiments of the present invention.

Referring to FIG. 1, the system for providing the pickup service according to various exemplary embodiments of the present invention may include a server 100, a vehicle terminal 200, and a user terminal 300.

The server 100 may recommend an optimal pickup position to a user and a vehicle using a current position of the user and a driving route of the vehicle. In the instant case, the server 100 may apply a weight to a time required to reach a destination, a time taken for the user to reach a pickup position on foot, a position characteristic (e.g., whether it is possible for the user to access a position or the like), a traffic situation (e.g., congestion), or the like to determine the optimal pickup position and may provide the vehicle terminal 200 and the user terminal 300 with the calculation optimal pickup position.

When receiving pickup position information (e.g., an address of a pickup position or a route to the pickup position) from the server 100, the vehicle terminal 200 may display the route to the pickup position to guide a driver along the route.

In the instant case, the vehicle terminal 200 may be implemented in the vehicle and may be integrally configured with control units in the vehicle or may be implemented as a separate device to be connected to the control units of the vehicle by a separate connection means.

The vehicle terminal 200 may include a communication device configured for vehicle-to-vehicle (V2V) communication and wireless communication with the server 100 or the user terminal 300, a display for guiding the driver along a route, a storage for storing information, map information, or the like received from the server 100 or the user terminal 300, a controller configured for controlling an operation of each component, or the like. Furthermore, the vehicle terminal 200 may include a communication device, a display, an audio device, a navigation device, or the like loaded into the vehicle and may share and guide its current position, a pickup position, a route to a destination, and the like through real-time communication with the server 100.

The user terminal 300 may be a mobile communication terminal, which may include a communication device, a display, a global positioning system (GPS) module, or the like. The user terminal 300 may communicate with the vehicle terminal 200 and the server 100, may share its position information with the vehicle terminal 200 and the server 100, and may receive position information of the vehicle terminal 200 from the vehicle terminal 200 or the server 100.

As an example, the user terminal 300 may include a smartphone, a table personal computer (PC), a mobile phone, a video phone, an e-book reader, a netbook computer, a personal digital assistant (PDA), a portable multimedia player (PMP), a mobile communication terminal, an electronic note, or the like and may include all devices configured for installing a navigation application. Furthermore, a server interworking application, a vehicle interworking application, and the like, which interwork with the server 100 and the vehicle terminal 200, may be provided in the user terminal 300. The server interworking application and the vehicle interworking application may be downloaded through wireless communication, the Internet, or the like and then be automatically provided.

The vehicle terminal 200 and the user terminal 300 may share their positions with each other via the server 100 and may mutually transmit a uniform resource locator (URL) for selecting a pickup position, finalizing the pickup position, and providing a route to the pickup position, thus providing a pickup service.

Furthermore, the vehicle terminal 200 and the user terminal 300 may allow a driver of a vehicle for pickup and a user scheduled to ride in the vehicle to select pickup positions they want and identify the position selected by the counterpart.

Furthermore, the vehicle terminal 200 and the user terminal 300 may receive a recommendation for an optimal pickup position from the server 100, rather than directly receiving a selection of a pickup position from the driver or the user. The server 100 may consider a vehicle route of the driver, a current position of the user, a road situation, and the like in an overall manner to list up and recommend suitable positions. In the instant case, the server 100 may analyze situations of the listed-up pickup positions and may notify the driver or the user of a singular point. For example, when the pickup position selected by the driver or the user is a no stopping area or is hard to reach on foot, the server 100 may notify the driver or the user of corresponding contents.

Furthermore, the server 100 may analyze a situation around the pickup position selected by the driver or the user and may notify the driver or the user of a singular point.

Furthermore, the vehicle terminal 200 and the user terminal 300 may share the pickup position with each other and may transmit and receive a short message which is previously defined or directly input. For example, when sharing the pickup position with each other, the vehicle terminal 200 and the user terminal 300 may share pieces of contact information of the driver and the user or the like with each other.

Furthermore, the vehicle terminal 200 and the user terminal 300 may finalize or deny the pickup position selected and shared by the counterpart.

Furthermore, the vehicle terminal 200 and the user terminal 300 may share a route to the finalized pickup position by a URL and may guide the driver and the user along the shared route.

Accordingly, in a state where the driver and the user share their positions by the vehicle terminal 200 and the user terminal 300, of the present invention an exemplary embodiment of the present invention may provide a pickup service through interworking among the server 100, the vehicle terminal 200, and the user terminal 300 to conveniently proceed with picking up the user.

Referring to FIG. 2, the server 100 for providing a pickup service may include a communication device 110, a storage 120, and a processor 130.

The communication device 110 may be a hardware device implemented with various electronic circuits to transmit and receive a signal through a wireless or wired connection.

Furthermore, the communication device 110 may communicate with the vehicle terminal 200, the user terminal 300, and the like by a wireless Internet technology. As an example, the communication device 110 may transmit and receive position information of each of the vehicle terminal 200 and the user terminal 300, a selected pickup position, a pickup position list, route information, or the like. Herein, the wireless Internet technology may include wireless local area network (WLAN), wireless broadband (WiBro), wireless-fidelity (Wi-Fi), Worldwide Interoperability for Microwave Access (WiMAX), or the like. Furthermore, the short range communication technology may include Bluetooth, ZigBee, ultra wideband (UWB), radio frequency identification (RFID), infrared data association (IrDA), or the like. As an example, the communication device 110 may transmit an optimal pickup position list or the like for providing a pickup service to the user terminal 300. Furthermore, the communication device 110 may communicate with the vehicle terminal 200 to share information related to a pickup position selected by the user terminal 300.

The storage 120 may store data, an algorithm, and/or the like necessary for an operation of the processor 130.

As an example, the storage 120 may store map information, a pickup position list, or the like.

The storage 120 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The processor 130 may be electrically connected to the communication device 110, the storage 120, or the like and may electrically control the respective components. The processor 130 may be an electrical circuit which executes instructions of software and may perform a variety of data processing and calculation described below.

The processor 130 may process a signal delivered between the respective components of the server 100 and may perform the overall control such that the respective components may normally perform their own functions.

Such a processor 130 may be implemented in a form of hardware, may be implemented in a form of software, or may be implemented in a form of a combination thereof The processor 130 may be implemented as a microprocessor.

The processor 130 may share a list of pickup positions which are places where the user rides in the vehicle with the vehicle terminal 200 or the user terminal 300 based on the route of the vehicle and the position of the user. Furthermore, the processor 130 may extract at least one pickup position candidate within a predetermined radius from the current position of the user.

In other words, the processor 130 may extract the at least one pickup position candidate based on at least one of a route of the vehicle, a position of the user, a movement route of the user, whether it is possible for the vehicle to stop, or a congestion situation.

The processor 130 may extract a road or an intersection within a predetermined radius around the current position of the user as at least one pickup position candidate.

The processor 130 may extract a position each direction (e.g., East, West, South, and North) on the road or the intersection within the predetermined radius around the current position of the user as at least one pickup position candidate.

The processor 130 may assign a weight to at least one pickup position candidate using at least one of a road type of the at least one pickup position candidate, a probability that a user will access the at least one pickup position candidate, a difference in required time between an old route from a starting point to a destination and a new route rediscovered by setting the at least one pickup position candidate to a stop, a time taken for the user to reach the at least one pickup position candidate, or traffic congestion.

When the road type of the at least one pickup position candidate is at least one of a highway, an underpass, or an overpass, the processor 130 may delete the at least one pickup position candidate. In other words, the processor 130 may delete a pickup position candidate, for example, a road it is impossible for the user to access on foot or a road where it is difficult for the vehicle to stop.

The processor 130 may list up the highest pickup position candidate among the at least one pickup position candidate based on the weight and may share the list of the pickup positions with the vehicle terminal 200 and the user terminal 300.

When directly receiving the selection of the pickup position from the user terminal 300 or the vehicle terminal 200, the processor 130 may determine a road type of the selected pickup position or a probability that the user will access the selected pickup position.

Furthermore, when it is impossible for the user to access the selected pickup position on foot or when the vehicle is unable to stop on the selected pickup position, the processor 130 may notify the user terminal 300 or the vehicle terminal 200 that it is impossible to pick up the user.

Furthermore, when it is possible for the user to access the selected pickup position on foot or when the vehicle is able to stop on the selected pickup position, the processor 130 may request the user terminal 300 or the vehicle terminal 200 to finalize the selected pickup position.

When the finalization of the selected pickup position is received from the user terminal 300 or the vehicle terminal 200, the processor 130 may provide the user terminal 300 or the vehicle terminal 200 with a route where the selected pickup position is set to a stop.

The processor 130 may provide the user terminal 300 or the vehicle terminal 200 with a URL for selecting the pickup position or guiding the user or the vehicle along the route to the determined pickup position.

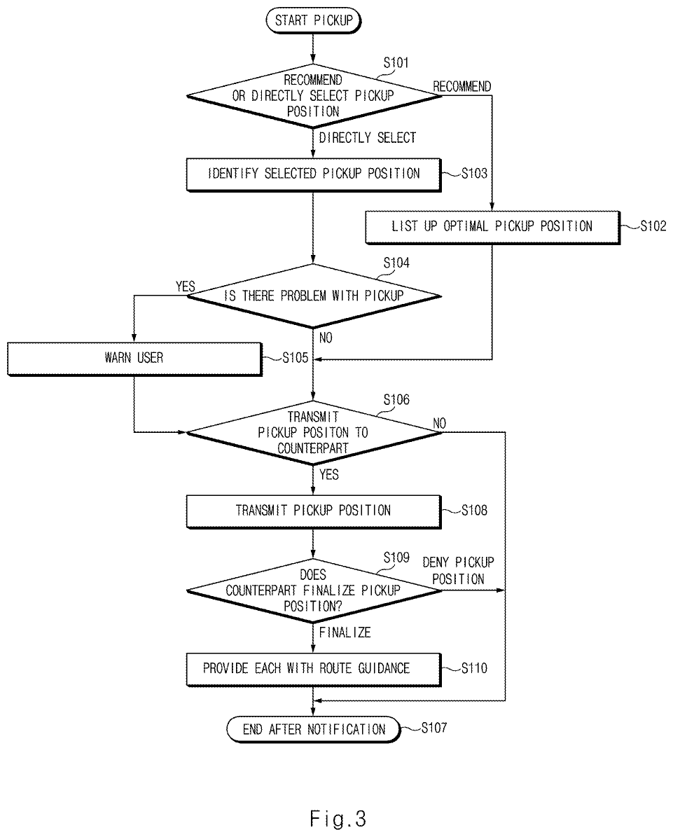

Hereinafter, a description will be provided in detail of a method for providing a pickup service according to various exemplary embodiments of the present invention with reference to FIG. 3. FIG. 3 is a flowchart illustrating a method for providing a pickup service according to various exemplary embodiments of the present invention.

Hereinafter, it is assumed that a server 100 for providing a pickup service in FIG. 1 performs a process of FIG. 3. Furthermore, in a description of FIG. 3, an operation referred to as being performed by the server 100 may be understood as being controlled by a processor 130 of the server 100.

Referring to FIG. 3, in S101, the server 100 may allow a driver or a user (a person scheduled to ride in the vehicle) to select whether to directly select a pickup position or to receive a pickup position list from the server 100. In the instant case, a vehicle terminal 200 and a user terminal 300 of FIG. 1 may include a terminal of the user who subscribes to a pickup service. In the instant case, the driver may select a pickup position using his or her mobile communication terminal rather than the vehicle terminal 200 or may request the server 100 to list up the pickup position.

When receiving the request to recommend the pickup position from the user terminal 300, in S102, the server 100 may provide the user terminal 300 with an optimal pickup position list.

Meanwhile, when directly receiving a selection of the pickup position from the user terminal 300, in S103, the server 100 may identify the selected pickup position. In S104, the server 100 may determine whether there is a problem with the selected pickup position. The server 100 may determine whether the road of the selected pickup position is a road where the vehicle is able to stop or a road accessible to the user depending on a road type of the selected pickup position to determine whether it is possible to use the pickup position. For example, when the pickup position is a highway, an underpass, an overpass, or the like, because the pickup position is a road where it is impossible to pick up the user, the server 100 may determine that there is a problem with the pickup position to exclude the pickup position.

When it is determined that there is the problem with the selected pickup position, in S105, the server 100 may warn the user about the selected pickup position by the user terminal 300. In the instant case, the server 100 may transmit warning text, or the like to the user terminal 300.

On the other hand, when it is determined that there is no problem with the selected pickup position, in S106, the server 100 may allow the user to select whether to transmit a pickup position to a driver (a counterpart) of the vehicle to pick up the user, by the user terminal 300.

When the user does not permit to share the pickup position, in S108, the server 100 may notify the vehicle terminal 200 that the pickup position is not shared to end the process.

Meanwhile, when the user permits to share the pickup position, in S108, the server 100 may transmit the pickup position to the vehicle terminal 200 of the vehicle to pick up the user and may share the pickup position with the vehicle terminal 200.

In S109, the server 100 may determine whether the driver of the vehicle terminal 200 finalizes pickup to the shared pickup position, through communication with the vehicle terminal 200. When the pickup is finalized, in S1110, the server 100 may provide each of the user terminal 300 and the vehicle terminal 200 with route guidance to the pickup position.

Meanwhile, when receiving the denial of pickup to the pickup position from the vehicle terminal 200 in S109, in S107, the server 100 may notify the user terminal 300 that the pickup position is denied to end the process.

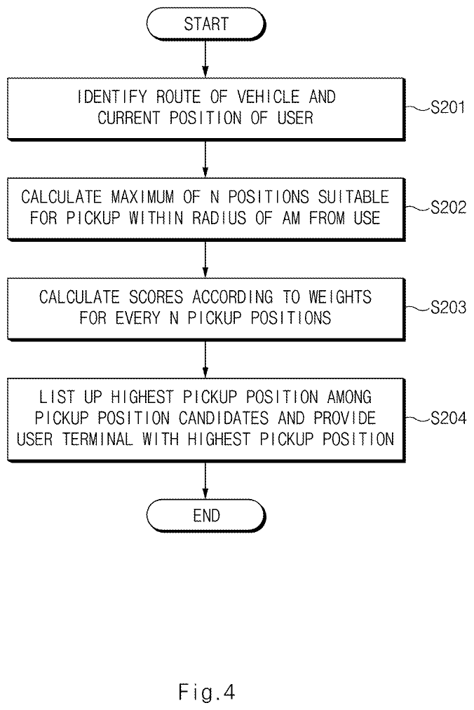

Hereinafter, a description will be provided in detail of a method for selecting a pickup position according to various exemplary embodiments of the present invention with reference to FIG. 4. FIG. 4 is a flowchart illustrating a method for selecting a pickup position according to various exemplary embodiments of the present invention.

Hereinafter, it is assumed that a server 100 for providing a pickup service in FIG. 1 performs a process of FIG. 4. Furthermore, in a description of FIG. 4, an operation referred to as being performed by the server 100 may be understood as being controlled by a processor 130 of the server 100. FIG. 4 includes S102 in more detail.

Referring to FIG. 4, in S201, the server 100 may identify a route of a vehicle and a current position of a user. In the instant case, the server 100 may receive vehicle route information from a vehicle terminal 200 of FIG. 1 to identify the route of the vehicle and may receive current position information of the user from a user terminal 300 of FIG. 1 to identify the current position of the user.

In S202, the server 100 may extract a position suitable for pickup within a radius of a predetermined distance Am from the user and may extract a maximum of N pickup position candidates.

For example, the server 100 may classify roads, within a radius of 200 m from the user terminal 300, for each direction and may list up the roads as pickup position candidates.

Furthermore, the server 100 may select an intersection within a radius of 200 m from the user terminal 300 and may list up a progress point for each direction at the intersection as a pickup position candidate.

In S203, the server 100 may determine scores according to weights for every N pickup position candidates. In S204, the server 100 may list up the highest pickup position among the pickup position candidates based on the scores according to the weights and may provide the user terminal 300 with the highest pickup position.

The server 100 may select a pickup position candidate using whether it is possible for the vehicle to stop depending on a road type of the pickup position candidate, whether it is possible for the user to access the vehicle, whether it is possible to pick up the user, or the like. For example, when the road of the pickup position candidate is a highway, an underpass, an overpass, or the like, because it is impossible for the vehicle to stop, when it is impossible for the user to access the vehicle, and when it is impossible for the vehicle to pick up the user, the server 100 may exclude the pickup position from the pickup position candidate.

Furthermore, the server 100 may determine a weight score depending on a difference in required time between an old route and a new route where the pickup position candidate is set to a stop. For example, when a time taken to reach a destination when the pickup position candidate is set to a stop more increases than a time taken to reach a destination of the old route by 20 minutes, the server 100 may weight 20 points as a weight score. Furthermore, the server 100 may reflect a current traffic situation when determining a time required for a route. The server 100 may receive the current traffic situation in real time from an external traffic server or the like.

The server 100 may determine a weight depending on a traffic congestion degree of the pickup position candidate. For example, because it is more difficult for the vehicle to form a lane change and stop when traffic congestion is severe, the server 100 may weight a weight score in five steps by two scores for each step independently of a time taken.

The server 100 may determine a weight depending on whether it is easy for the user to access the pickup position candidate. For example, the server 100 may determine user accessibility on the basis of time and may assign a weight which is twice as much as a time when it is possible for the user to access the vehicle on foot.

The example in which the server 100 extracts the pickup position candidate is included in FIG. 4 according to various exemplary embodiments of the present invention, but the vehicle terminal 200 may extract a pickup position candidate. In the instant case, the server 100 may play a role in transmitting and receiving data between the vehicle terminal 200 and the user terminal 300.

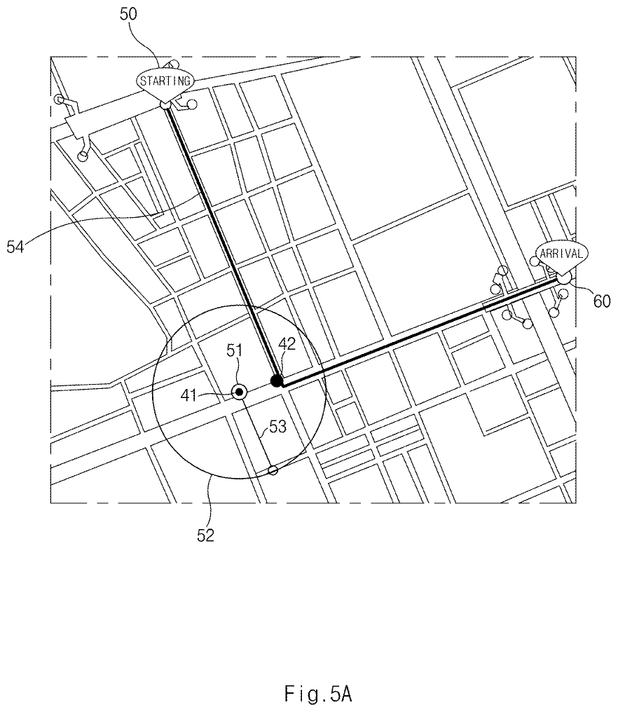

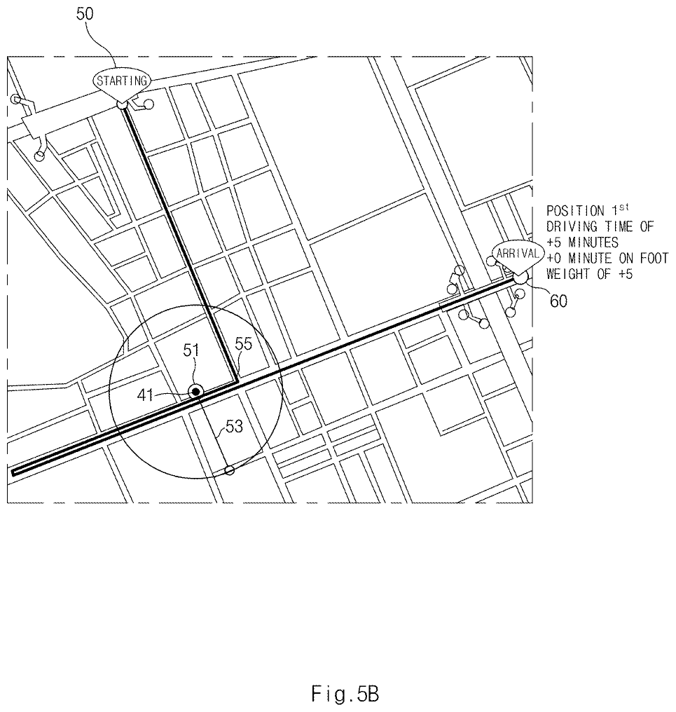

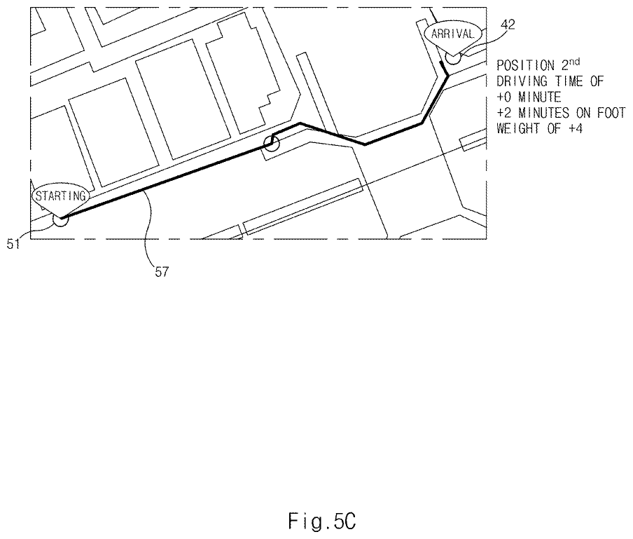

FIG. 5A, FIG. 5B, and FIG. 5C are exemplary drawings illustrating a process of selecting a pickup position according to various exemplary embodiments of the present invention.

For example, when the position of a user 51 is a center portion point of a circle 52, on a route from a starting point 50 to an arrival point (a destination) 60, a pickup position candidate may be selected in the following manner.

First of all, a server 100 of FIG. 2 may select a predetermined radius 53 (e.g., 200 m) with respect to the position of the user 51 and may select a road or an intersection in the radius 53 as a pickup position candidate 41 or 42.

In other words, in FIG. 5A, the server 100 may select the road right in front of the position of the user 51 as the pickup position candidate 41, in a state where the user is spaced from a route on the route from a starting point 50 to an arrival point 60 or may select a position in an old route 54 of the vehicle, to which the user 51 directly moves on foot on the road in the old route 54 of the vehicle, as the pickup position candidate 42.

FIG. 5B is an example of selecting the road right in front of the position of the user 51 as the pickup position candidate 41. The server 100 may rediscover a route by setting the pickup position candidate 41 to a stop and may compare a time taken to reach an arrival point of the old route 54 with a time taken to reach an arrival point of a newly discovered new route 55. In other words, as shown in FIG. 5B, when the time taken on the old route 54 is 8 minutes, when the time taken on the new route 55 is 13 minutes and increases by 5 minutes, and when the movement time of the user on foot is “0”, the server 100 may assign a weight of 5 points to the pickup position candidate 41.

FIG. 5C includes an example in which the user 51 moves on foot to the pickup position candidate 52 on the road in the old route 54 of the vehicle and rides in the vehicle at the pickup position candidate 42.

In the instant case, as the user 51 directly moves on foot from the current position to the pickup position candidate 42, before the movement time according to a movement distance 57 of the user 51 on foot increases by 2 minutes, but because the pickup position candidate 42 is within the old route 54 and has an influence on a time taken to reach a destination, the server 100 may assign a weight to the pickup position candidate 42 by “+4”.

Thus, weight scores of the pickup position candidates 41 and 42 are respectively “+5” and “+4”. The server 100 may first list up the pickup position candidate 42 with the low weight score and may recommend the pickup position candidate 42 to the user terminal 300 and the vehicle terminal 200.

In the instant case, a description will be provided assuming that road congestion situations are similar to each other in the situations of FIG. 5B and 5C. Furthermore, the higher the weight score, the lower the optimality of the pickup position may be set to be. Herein, of the present invention an exemplary embodiment of the present invention is referred to as an example in which the lower the weight score, the higher the priority, but this may vary with situations in various manners. For example, the higher the optimality of the pickup position, the higher the weight score may be set to be assigned.

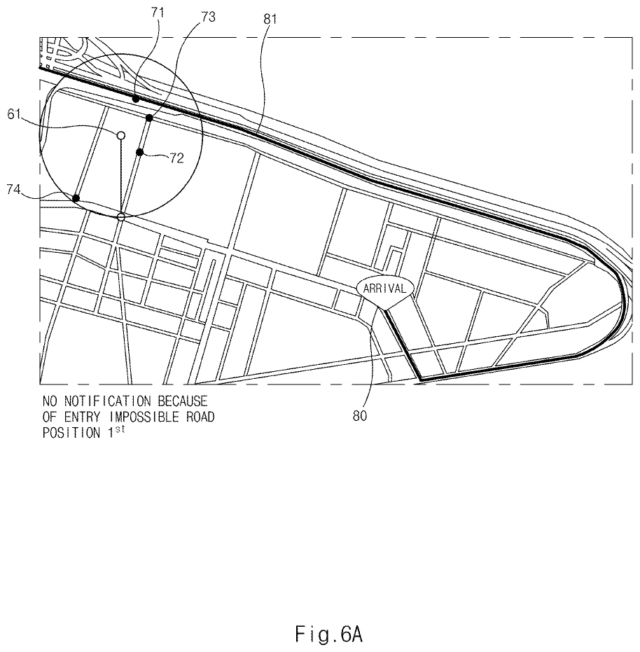

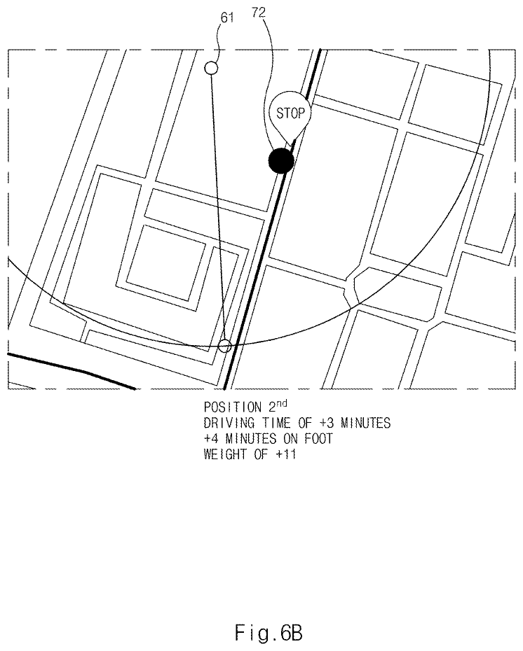

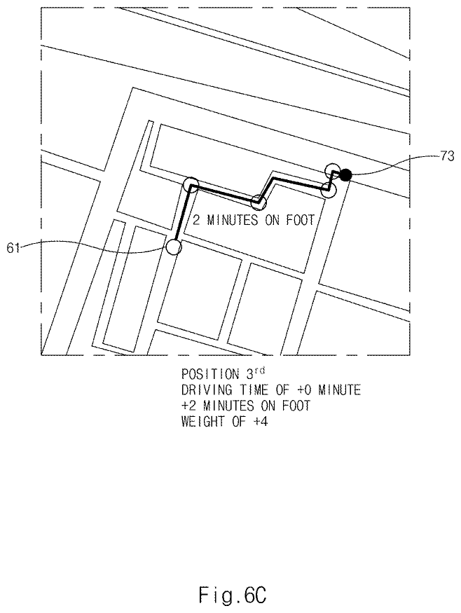

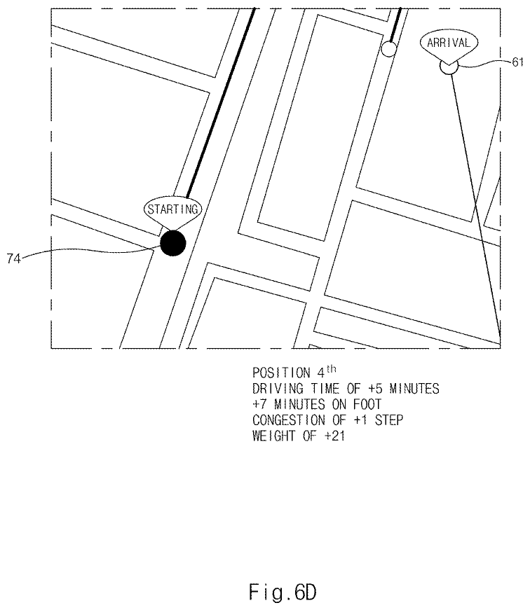

FIG. 6A, FIG. 6B, FIG. 6C, and FIG. 6D are exemplary drawings illustrating a process of selecting a pickup position according to various exemplary embodiments of the present invention.

For example, when the position of a user 61 is a center portion point of a circle, on a route from a starting point 70 to an arrival point 80, a pickup position candidate may be selected in the following manner.

Referring to FIG. 6A, a server 100 of FIG. 1 may select a radius of 200 m with respect to the position of a user 61 and may select a road, an intersection, or the like in the radius as a pickup position candidate. In other words, the server 100 may select a road 71 on an old route which is present within a predetermined radius with respect to the position of the user 61, a near road 72 to which the user 61 is movable on foot from the position of the user 61, and intersections 73 and 74 around the position of the user 61 as pickup position candidates.

In FIG. 6A, although there is an old route 81 within the predetermined radius from the position of the user 61, when the pickup position candidate 71 on the road on the old route 81 is a road it is impossible for the user to enter on foot, the server 100 may exclude the pickup position candidate 71 from a pickup position candidate list.

Referring to FIG. 6B, when selecting a road it is possible for the user 61 to access on foot from the position of the user 61 as a pickup position candidate 72, the server 100 may rediscover a route to a destination by setting the pickup position candidate 72 to a stop. Thus, as a time taken for the rediscovered new route more increases by 3 minutes than the old route and as a time taken for the user to walk on foot increases by 4 minutes than the old route, the server 100 may assign a weight of 11 to the pickup position candidate 72.

Referring to FIG. 6C, when the pickup position candidate 72 is an intersection on the old route, as there is no change because a time taken to reach the destination is 35 minutes and as a time taken for the user to walk on foot is 2 minutes, the server 100 may assign a weight of 2 to the pickup position candidate 73.

Referring to FIG. 6D, for a pickup position candidate 74 which is another intersection near the position of the user 61, when rediscovering a route by setting the pickup position candidate 74 to a stop, the new route more increases by 5 minutes than the old route as a time taken on the new route is 40 minutes, a time taken for the user to walk on foot to the pickup position candidate 74 is 7 minutes, and congestion on the new route is higher than other sections by +1 step. Thus, the server 100 may assign the highest weight of 21 to the pickup position candidate 74.

Thus, because weight scores of the pickup position candidates 72, 73, and 74 are 11, 4, and 21, respectively, the server 100 may sequentially list up and recommend the pickup position candidates 73 and 72 from the pickup position candidate 73 with the lowest weight score and may exclude the pickup position candidate 71 from the list.

In the above-mentioned examples of FIGS. 5A to 6D, numerical values such as a distance, a number, and a radius referred to as an exemplary embodiment are not limited thereto and are changeable at any time if necessary.

When selecting a pickup position, the server 100 may select a shorter time between a time when the user moves to the pickup position and a time when the vehicle travels to the user position and may determine a priority of a pickup position candidate. When the user or the driver selects a pickup position by a user terminal 300 or a vehicle terminal 200 of FIG. 1, the sever 100 may select a shorter time between a time when the user moves to the pickup position and a time when the vehicle travels to the user position and may determine a priority of a pickup position candidate.

Furthermore, the server 100 may set a criterion of a weight assigned to a pickup position candidate in various manners. For example, the server 100 may more assign a weight to movement on foot or may set a weight on a congestion section to be higher. Even when the user or the driver selects a pickup position by the user terminal 300 or the vehicle terminal 200, the server 100 may assign and determine a weight to each pickup position and may provide the user with the above-mentioned changeable contents as an option, thus providing all functions.

Accordingly, of the present invention an exemplary embodiment of the present invention may more facilitate it when the driver picks up the user, using position information shared with each other. Various exemplary embodiments of the present invention may provide convenience to a driver who drives on an unfamiliar area and a user.

Furthermore, of the present invention an exemplary embodiment of the present invention may provide the user terminal 300 and the vehicle terminal 200 with a pickup position candidate list through the server 100 to minimize another action of the driver who is driving the vehicle, thus helping the driver perform safe driving.

Furthermore, of the present invention an exemplary embodiment of the present invention may provide the driver and the user with an optimal driving route, thus smoothing the flow of traffic.

The present technology may share positions between a driver and a user who is a person scheduled to ride in the vehicle when the driver picks up the person scheduled to ride in the vehicle and may provide the driver of the vehicle and the user with an optimal pickup position based on the current position of the user and the route of the vehicle, thus increasing convenience of the driver and the person scheduled to ride in the vehicle.

Furthermore, various effects ascertained directly or indirectly through the present invention may be provided.

Hereinabove, although the present invention has been described with reference to exemplary embodiments and the accompanying drawings, the present invention is not limited thereto, but may be variously modified and altered by those skilled in the art to which various exemplary embodiments of the present invention pertains without departing from the spirit and scope of the present invention claimed in the following claims.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A server for providing a pickup service, the server comprising:
a communication device configured to communicate with a vehicle terminal of a vehicle which is traveling according to a route from a starting point to a destination and a user terminal of a user scheduled to ride in the vehicle;
a processor configured to share a list of pickup positions which are places where the user rides in the vehicle with the vehicle terminal or the user terminal based on the route of the vehicle and a position of the user; and
a storage storing data and an algorithm run by the processor.

2. The server of claim 1, wherein the processor is configured to extract at least one pickup position candidate within a predetermined radius from a current position of the user.

3. The server of claim 2, wherein the processor is configured to extract the at least one pickup position candidate based on at least one of the route of the vehicle, the position of the user, a movement route of the user, whether it is possible for the vehicle to stop, or a congestion situation.

4. The server of claim 2, wherein the processor is configured to extract a road or an intersection within the predetermined radius around the current position of the user as the at least one pickup position candidate.

5. The server of claim 4, wherein the processor is configured to extract a position for each direction on the road or the intersection within the predetermined radius around the current position of the user as the at least one pickup position candidate.

6. The server of claim 2, wherein the processor is configured to assign a weight to at least one pickup position candidate using at least one of a road type of the at least one pickup position candidate, a probability that the user will access the at least one pickup position candidate, a difference in time taken between an old route from the starting point to the destination and a new route rediscovered by setting the at least one pickup position candidate to a stop, a time taken for the user to reach the at least one pickup position candidate, or traffic congestion.

7. The server of claim 6, wherein the processor is configured to delete the at least one pickup position candidate, when the road type of the at least one pickup position candidate is at least one of a highway, an underpass, or an overpass.

8. The server of claim 6, wherein the processor is configured to list up a highest pickup position candidate among the at least one pickup position candidate based on the weight and to share the list of the pickup positions with the vehicle terminal and the user terminal.

9. The server of claim 1, wherein the processor is configured to determine a road type of a selected pickup position and a probability that the user will access the selected pickup position, when directly receiving selection of the pickup position from the user terminal or the vehicle terminal.

10. The server of claim 9, wherein the processor is configured to provide the user terminal or the vehicle terminal with a notification that it is impossible to pick up the user, when it is impossible for the user to access the selected pickup position on foot or when the vehicle is unable to stop on the selected pickup position.

11. The server of claim 9, wherein the processor is configured to request the user terminal or the vehicle terminal to finalize the selected pickup position, when it is possible for the user to access the selected pickup position on foot and when the vehicle is able to stop on the selected pickup position.

12. The server of claim 11, wherein the processor is configured to provide the user terminal or the vehicle terminal with a route where the selected pickup position is set to a stop, when the processor receives the finalization of the selected pickup position from the user terminal or the vehicle terminal.

13. The server of claim 12, wherein the processor is configured to provide the user terminal or the vehicle terminal with a uniform resource locator (URL) for selecting the pickup position or guiding the user or the vehicle along a route to the finalized pickup position.

14. A system for providing a pickup service, the system comprising:
a vehicle terminal of a vehicle traveling according to a route from a starting point to a destination;
a user terminal of a user scheduled to ride in the vehicle; and
a server configured to share a list of pickup positions which are places where the user rides in the vehicle with the vehicle terminal or the user terminal based on the route of the vehicle and a position of the user, through communication with the vehicle terminal or the user terminal.

15. The system of claim 14, wherein the vehicle terminal, the user terminal, and the server share current positions of the vehicle terminal and the user terminal with one another.

16. The system of claim 15, wherein the user terminal selects one of pickup positions included in the list of the pickup positions, when receiving the list of the pickup positions from the server.

17. The system of claim 16, wherein the vehicle terminal finalizes the selected pickup position, when the pickup position selected by the user terminal is shared.

18. The system of claim 17, wherein the server provides the vehicle terminal and the user terminal with a route to the selected pickup position, when the selected pickup position is finalized by the vehicle terminal.

19. A method for providing a pickup service, the method comprising:
receiving a position of a vehicle and a position of a user and a route of the vehicle from a vehicle terminal of the vehicle traveling according to the route from a starting point to a destination and a user terminal of the user scheduled to ride in the vehicle; and
sharing a list of pickup positions which are places where the user rides in the vehicle with the vehicle terminal or the user terminal based on the route of the vehicle and the position of the user.

20. The method of claim 19,
wherein the sharing of the list of the pickup positions with the vehicle terminal or the user terminal includes extracting at least one pickup position candidate within a predetermined radius from a current position of the user, and
wherein the at least one pickup position candidate is extracted based on the route of the vehicle, the position of the user, a movement route of the user, whether it is possible for the vehicle to stop, or a congestion situation.
